(19) United States
(12) Patent Application Publication
(10) Pub. No.: US 2002/0104089 A1
(43) Pub. Date: Aug. 1, 2002

(54) Data broadcast receiving system

(76) Inventors: Takahiro Hiramatsu, Tokyo (JP); Koichi Nakashima, Tokyo (JP); Koichi Hiramatsu, Tokyo (JP)

Correspondence Address: BIRCH STEWART KOLASCH & BIRCH, PO BOX 747, FALLS CHURCH, VA, 22040-0747, US

(21) Appl. No.: 09/971,026

(22) Filed: Oct. 5, 2001

(30) Foreign Application Priority Data
Jan. 31, 2001 (JP) 2001-24375

(51) Int. Cl. H04N 5/445; G06F 13/00

(52) U.S. Cl. 725/51; 725/59

(57) ABSTRACT

In cases where a selection item I1 is selected from a plurality of selection items on a browser screen, the selection items are arranged according to position information of the selection items described in a BML document and are displayed on the browser screen by a function of a selection item displaying unit, the judgment whether or not a cursor is placed on a display area of one selection item on the browser screen is performed in a selection item determining unit, it is detected that the cursor is placed on the display area of a selection item I1, and the selection item I1 is set to a selected state. Also, in cases where a change of the selection item I1 set to the selected state to a selection item I2 is performed, the cursor is placed on the display area of the selection item I2, and the transfer of the selected state from the selection item I1 to the selection item I2 is performed according to a state transition diagram defined by the BML document. Accordingly, operability in both the selection of a desired selection item and the transfer of the selected state can be heightened.

### BACKGROUND OF THE INVENTION

1. Field of the Invention

The present invention relates to a data broadcast receiving system in which contents of a data broadcast signal superposed on a digital broadcast signal are received.

2. Description of Related Art

Television broadcasting has been recently digitalized. In the digital television broadcasting, various types of data can be broadcasted in addition to visual and audio data of which a signal is also included in a conventional analog television broadcast signal. For example, contents composed of character information and multimedia data are broadcasted in the data broadcasting. Therefore, a data broadcast receiving system has been widely used to present the contents composed of character information and multimedia data to users.

In the data broadcast receiving system, a remote control device having an up button, a down button, a right button, a left button and a determination button is used to operate a browser and to select desired data of contents. That is, a user selects a selection item from a plurality of displayed items by using the up, down, right and left buttons, determines the selection item by using the determination button and displays desired data of the selection item.

FIG. 6 is a diagonal view showing a conventional data broadcast receiving system. In FIG. 6, 1 indicates a conventional data broadcast receiving device. 2 indicates an image display device such as a television set. 3 indicates a browser screen of the image display device 2. 4 indicates a selection item I1 displayed on the browser screen 3. 5 indicates a selection item I2 displayed on the browser screen 3. 6 indicates a selection item I3 displayed on the browser screen 3.

7 indicates a remote control unit for operating the conventional data broadcast receiving device 1. 8 indicates an up button. 9 indicates a down button. 10 indicates a left button. 11 indicates a right button. 12 indicates a determination button.

Next, an operation of the conventional data broadcast receiving system will be described below.

When a type of data called a broadcast markup language (BML) document is received in the conventional data broadcast receiving device 1, the data is analyzed, and the BML document is displayed on the browser screen 3 of the image display device 2.

Here, FIG. 2 is an explanatory view showing an example of a BML document. In FIG. 2, 21 indicates a BML document. 22 indicates position information indicating a display position of the selection item I1. 23 indicates selection item order information indicating both a type of button and a selection item newly set to a selected state by operating the type of button. That is, when the selection item I1 is currently set in the selected state, it is possible to transfer a selected state from the selection item I1 to the selection item I2 by operating the down button 9.

24 indicates position information indicating a display position of the selection item I2. 25 indicates selection item order information indicating types of buttons and a selection item newly set to a selected state by operating each type of button. That is, when the selection item I2 is currently set in the selected state, it is possible to transfer a selected state from the selection item I2 to the selection item I1 by operating the up button 8, and it is possible to transfer a selected state from the selection item I2 to the selection item I3 by operating the down button 9.

26 indicates position information indicating a display position of the selection item I3. 27 indicates selection item order information indicating both a type of button and a selection item newly set to a selected state by operating the type of button. That is, when the selection item I3 is currently set in the selected state, it is possible to transfer a selected state from the selection item I3 to the selection item I2 by operating the up button 8.

Therefore, the pieces of selection item order information 23, 25 and 27 indicate the order of selection items I1, I2 and I3 set to the selected state one after another by operating the up, down, right and left buttons 8 to 11.

28 indicates operation information indicating an operation performed when the selection of the selection item I1 is determined. 29 indicates operation information indicating an operation performed when the selection of the selection item I2 is determined. 30 indicates operation information indicating an operation performed when the selection of the selection item I3 is determined.

FIG. 3 shows a state transition diagram defined according to the BML document 21. In FIG. 3, 31 indicates a state in which the selection item I1 is selected. 32 indicates a state in which the selection item I2 is selected. 33 indicates a state in which the selection item I3 is selected.

As is apparent in FIG. 3, on condition that the selection item I1 is currently set in a selected state, when the down button 9 is pushed, the selected state is transferred to the selection item I2 according to both “nav-down: 2” described in the selection item order information 23 of the selection item I1 and “nav-index: 2” described in the selection item order information 25 of the selection item I2. In the same manner, on condition that the selection item I2 is currently set in a selected state, the selected state is transferred to the selection item I3 by pushing the down button 9, and the selected state is transferred to the selection item I1 by pushing the up button 8. Also, on condition that the selection item I3 is currently set in a selected state, when the up button 8 is pushed, the selected state is transferred to the selection item I2.

Therefore, the selected state can be transferred to any selection item displayed on the browser screen 3.

Here, when the selection item I1 is, for example, set to a selected state, an operation is performed according to information of “onfocus=“Dec1( );” described in the operation information 28 of the selection item I1. In the same manner, an operation is performed for each of the selection item I2 and the selection item I3.

Also, when the determination button 12 is pushed on condition that the selection item I1 is currently set in the selected state, an operation is performed according to information of “onclick=“Sell( );” described in the operation information 28 of the selection item I1. In the same manner, an operation is performed for each of the selection item I2 and the selection item I3.

However, in cases where there are a large number of selection items displayed on the browser screen 3, it is required to push the various types of buttons many times to transfer the selected state to a desired selection item. Therefore, a problem has arisen that the operation of selecting a desired selection item is troublesome.

Also, in cases where a plurality of selection items are diagonally arranged in a line, it is difficult to select a button for the purpose of transferring the selected state to a desired selection item.

### SUMMARY OF THE INVENTION

An object of the present invention is to provide, with due consideration to the drawbacks of the conventional data broadcast receiving system, a data broadcast receiving system in which operability in the selection of a desired selection item is heightened.

The object is achieved by the provision of a data broadcast receiving system comprising selection item displaying means for receiving a document, in which position information of a plurality of selection items is described, and displaying the selection items on a browser screen according to the position information of the selection items described in the document, cursor control means for controlling a position of a cursor displayed on the browser screen, and selection item determining means for judging whether or not the cursor controlled by the cursor control means is placed on a display area of one selection item displayed on the browser screen by the selection item displaying means and setting one selection item corresponding to one display area, on which the cursor is placed, to a selected state.

Therefore, any selection item can be set to a selection state without pushing buttons many times. Accordingly, operability in the selection of a desired selection item can be heightened.

It is preferred that a change of the selection item set to the selected state is performed by the selection item determining means according to selection item order information which indicates the order of selection items set to the selected state one after another by operating up, down, right and left buttons and is described in the document.

Therefore, mismatch of the operation of the data broadcast browser with the document prepared for the operation of the buttons can be prevented.

It is preferred that it is allowed to perform a change of one selection item set to the selected state to another second selection item through each of a plurality of routes, a shortest route is selected by the selection item determining means from the routes, and the change of one selection item set to the selected state to another second selection item is performed by the selection item determining means according to the selection item order information relating to the shortest route.

Therefore, the same operation as that performed by operating buttons can be efficiently performed in the change of the selection item set to the selected state.

It is preferred that the cursor control means is formed of a mouse.

Therefore, operability in the setting of the selection item to the selected state can be heightened.

It is preferred that the cursor control means is formed of a stick type input device.

Therefore, operability in the setting of the selection item to the selected state can be heightened.

It is preferred that the cursor control means is formed of a ball type input device.

Therefore, operability in the setting of the selection item to the selected state can be heightened.

It is preferred that the stick type input device is arranged on a remote control unit.

Therefore, operability in the selection of a desired selection item can be heightened by operating the remote control device.

It is preferred that the ball type input device is arranged on a remote control unit.

Therefore, operability in the selection of a desired selection item can be heightened by operating the remote control device.

### BRIEF DESCRIPTION OF THE DRAWINGS

FIG. 1 is a diagonal view showing a data broadcast receiving system according to first to sixth embodiments of the present invention;

FIG. 2 is an explanatory view showing an example of a BML document used in the prior art and the first and second embodiments;

FIG. 3 shows a state transition diagram defined according to the BML document shown in FIG. 2;

FIG. 4 is an explanatory view showing an example of another BML document according to a third embodiment;

FIG. 5 shows a state transition diagram defined according to the BML document shown in FIG. 4; and

FIG. 6 is a diagonal view showing a conventional data broadcast receiving system.

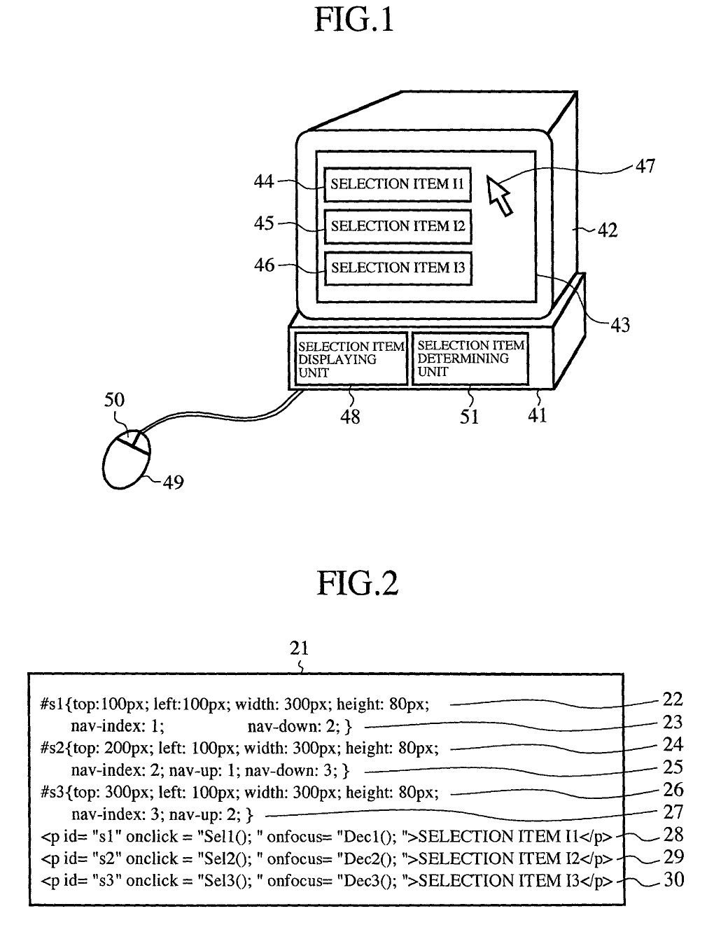

### DETAILED DESCRIPTION OF THE PREFERRED EMBODIMENTS

Embodiments of the present invention will now be described with reference to the accompanying drawings.

Embodiment 1

FIG. 1 is a diagonal view showing a data broadcast receiving system according to a first embodiment of the present invention.

In FIG. 1, 41 indicates a digital broadcast receiving device. 42 indicates an image display device such as a television set. 43 indicates a browser screen of the image display device 42. 44 indicates a selection item I1 displayed on the browser screen 43. 45 indicates a selection item I2 displayed on the browser screen 43. 46 indicates a selection item I3 displayed on the browser screen 43. 47 indicates a coordinate indication cursor displayed on the browser screen 43.

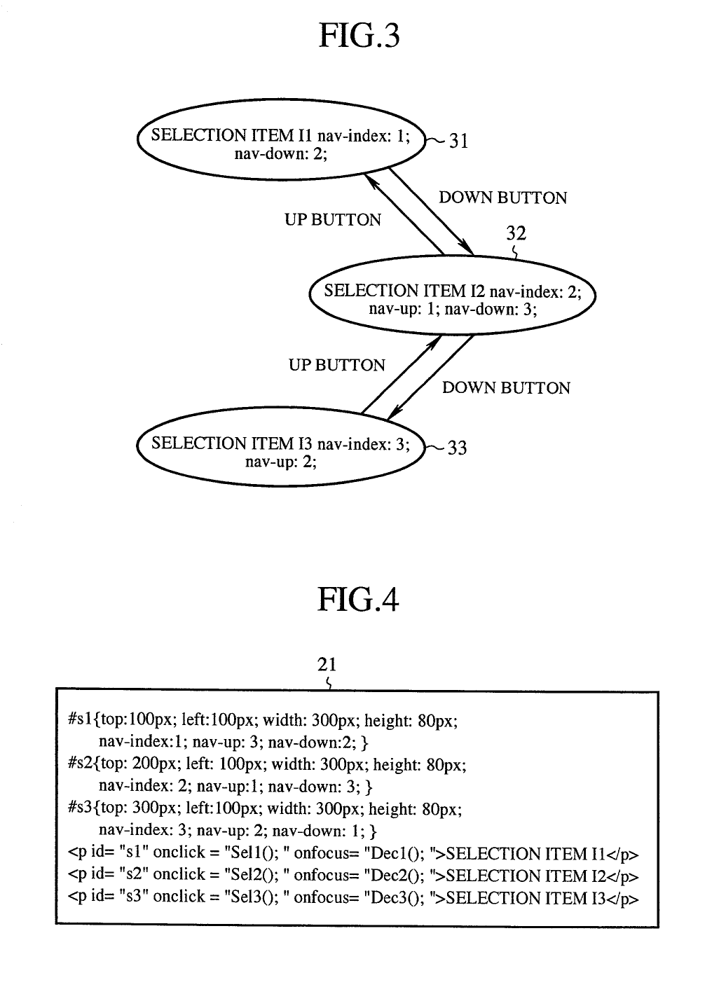

48 indicates a selection item displaying unit for receiving the BML document 21 shown in FIG. 3 and displaying the selection items I1, I2 and I3 according to position information of the selection items I1, I2 and I3 described in the BML document 21. 49 indicates a coordinate input device (or cursor control means) for controlling a position of the coordinate indication cursor 47 displayed on the browser screen 43. 50 indicates a button of the coordinate input device 49. 51 indicates a selection item determining unit for judging whether or not the coordinate indication cursor 47 is placed on a display area of one selection item displayed on the browser screen 43 and setting a specific selection item to a selected state in cases where the coordinate indication cursor 47 is placed on the display area of the specific selection item.

Next, an operation of the data broadcast receiving system will be described below.

When a type of data called the BML document 21 is received in the selection item displaying unit 48, the data of the BML document 21 is analyzed in the selection item displaying unit 48, and a plurality of selection items I1, I2 and I3 described in the BML document 21 are displayed on the browser screen 43 of the image displaying unit 42 by the selection item displaying unit 48 according to position information of the selection items I1, I2 and I3 described in the BML document 21. In this case, the position information of the selection items I1, I2 and I3 is also stored in a main storing unit or an auxiliary memory (not shown) under the control of the selection item displaying unit 48.

Thereafter, when a user operates the coordinate input device 49 to move the coordinate indication cursor 47, the selection item determining unit 51 of the digital broadcast receiving unit 41 refers to the position information of the selection items I1, I2 and 13 stored in the main storing unit or the auxiliary memory, and it is judged in the selection item determining unit 51 whether or not the coordinate indication cursor 47 is placed on a display area of one selection item displayed on the browser screen 43. Thereafter, in cases where the coordinate indication cursor 47 is placed on the display area of a specific selection item, the specific selection item is set to a selected state under the control of the selection item determining unit 51.

Therefore, any selection item displayed on the browser screen 43 of the image displaying unit 42 can be set to a selected state.

Thereafter, when the button 50 of the coordinate input device 49 is pushed on condition that one selection item is currently set to a selected state, the processing for the selection item is performed according to the operation information 28, 29 or 30 of the selection item.

As is described above, in the first embodiment, it is judged whether or not the coordinate indication cursor 47 is placed on a display area of one selection item displayed on the browser screen 43, and a specific selection item is set to a selected state in cases where the coordinate indication cursor 47 is placed on the display area of the specific selection item. Accordingly, operability in the selection of a desired selection item can be heightened.

Embodiment 2

In the first embodiment, in cases where no selection item is initially set to a selected state, an arbitrary selection item is set to a selected state. In contrast, in a second embodiment, in cases where a first selection item is currently set in a selected state, a second selection item is set to a selected state at a next time by performing a change of the first selection item set to the selected state to the second selection item. In this case, the transfer of the selected state is performed according to the selection item order information 23, 25 and 27 described in the BML document 21.

For example, when the BML document 21 is received in the selection item displaying unit 48, the selection items I1 to I3 are displayed on the browser screen 43 of the image displaying unit 42 according to the position information of the selection items I1, I2 and I3 described in the BML document 21. Thereafter, in cases where a user operates the coordinate input device 49 so as to transfer the selected state from the selection item I1 to the selection item I3 on condition that the selection item I1 is currently set in a selected state, the transfer of the selected state is performed according to the state transition diagram of the selection items I1, I2 and I3. The state transition diagram is described in the BML document 21 and is shown in FIG. 3.

In detail, when a user operates the coordinate input device 49 to place the coordinate indication cursor 47 on the display area of the selection item I3, the selected state is once transferred from the state 31 of the selection item I1 to the state 32 of the selection item I2 under the control of the selection item determining unit 51 according to the selection item order information 23 described in the BML document 21, and the selected state is transferred from the state 32 of the selection item I2 to the state 33 of the selection item I3 under the control of the selection item determining unit 51 according to the selection item order information 25 described in the BML document 21. In this case, an operation is automatically performed according to information of “onfocus=“Dec2( );” described in the operation information 29 of the selection item I2 during the selected state 32 of the selection item I2, and an operation is automatically performed according to information of “onfocus=“Dec3( );” described in the operation information 30 of the selection item I3 during the selected state 33 of the selection item I3.

Here, a producer of the BML document 21 presumes that the transfer of selected state is performed according to the BML document 21 by using up, down, right and left buttons. Therefore, there is a probability that it is necessary to perform the operation according to the information of “onfocus=“Dec3( );” after the performance of the operation according to the information of “onfocus=“Dec2( );”. In the second embodiment, the transfer of the selected state is performed according to the state transition diagram (refer to FIG. 3) defined by the BML document 21 when the coordinate input device 49 is operated to select a selection item. Therefore, the same operation as that performed by using the up, down, right and left buttons can be performed in the second embodiment by operating the coordinate input device 49.

Accordingly, mismatch of the operation of the data broadcast browser with the BML document can be prevented.

Embodiment 3

In the second embodiment, on condition that a first selection item is currently set in a selected state, a second selection item is set to a selected state by transferring the selected state from the first selection item to the second selection item according to the selection item order information 23, 25 and 27 described in the BML document 21. In contrast, in a third embodiment, in cases where there are a plurality of transition routes from a first selection item to a second selection item in the change of the first selection item set to a selected state, a shortest transition route is selected from the routes in the selection item determining unit 51, and the transfer of the selected state is performed according to the selection item order information relating to the shortest transition route.

That is, in the third embodiment, the same operation as that performed by using up, down, right and left buttons is performed by operating the coordinate input device 49. Also, in cases where there are a plurality of sets of operations using the up, down, right and left buttons in the transfer of the selected state, one set of operations, in which the number of operations is shortest, is selected, and the same procedure as that corresponding to the selected set of operations using the up, down, right and left buttons is performed in the transfer of the selected state.

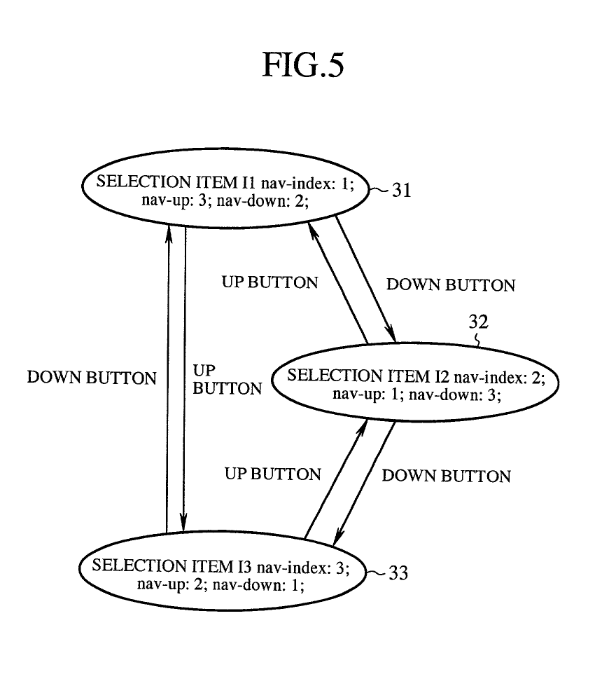

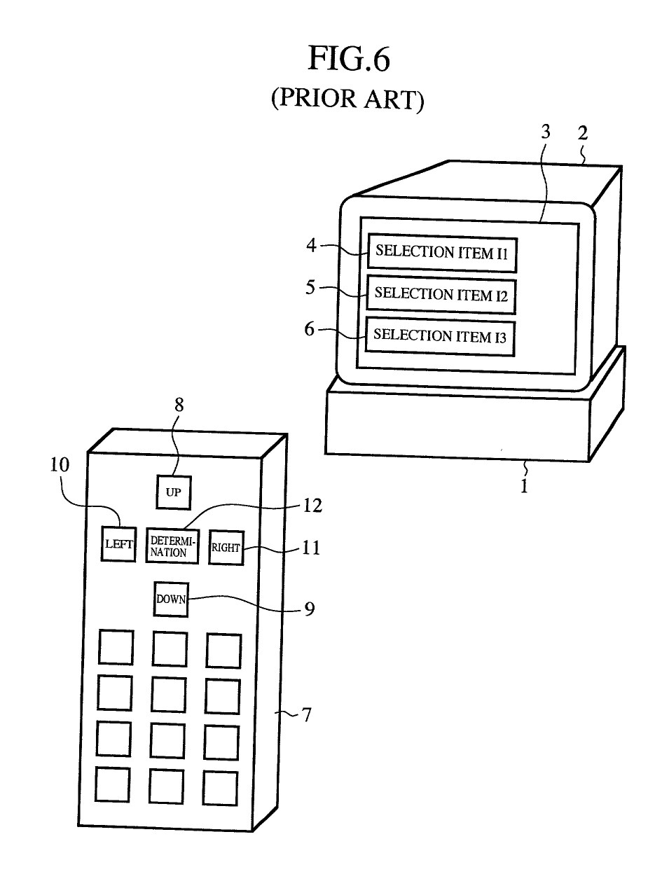

An operation of the transfer of the selected state performed in case of the reception of the BML document 21 shown in FIG. 4 will be described below as an example. In cases where the BML document 21 shown in FIG. 4 is received in the data broadcast receiving system, a state transition diagram defined by the BML document 21 is shown in FIG. 5.

In the example shown in FIG. 5, a route for the direct state transition between the selection item I1 and the selection item I3 is added as compared with the example shown in FIG. 3.

For example, when the BML document 21 is received in the selection item displaying unit 48, the selection items I1 to I3 are displayed on the browser screen 43 of the image displaying unit 42 according to the position information of the selection items I1, I2 and I3 described in the BML document 21. Thereafter, when a user operates the coordinate input device 49 to place the coordinate indication cursor 47 on the display area of the selection item I3 on condition that the selection item I1 is currently set in a selected state, the transfer of the selected state from the selection item I1 to the selection item I3 is performed. In this case, there are a transition route corresponding to the pushing of the up button 8 and a transition route corresponding to the pushing of the down button 9. In the transition route corresponding to the up button 8, the transfer of the selected state from the selection item I1 to the selection item I3 is performed by pushing the up button 8 only once. In contrast, in the transition route corresponding to the down button 9, the transfer of the selected state from the selection item I1 to the selection item I3 is performed by pushing the down button 9 twice.

In the selection item determining unit 51 of the digital broadcast receiving device 41, the number of operations for the buttons 8 to 11 in one transition route is compared with those in the other transition routes, and a shortest transition route corresponding to the minimum number of operations is selected. In the example shown in FIG. 5, because a state transition relating to the up button 8 pushed only once corresponds to a shortest route, the transfer of the selected state is performed along the transition route corresponding to the up button 8. That is, when a user operates the coordinate input device 49 to place the coordinate indication cursor 47 on the display area of the selection item I3, the selected state is directly transferred from the selected state 31 of the selection item I1 to the selected state 33 of the selection item I3 under the control of the selection item determining unit 51 according to information “nav-up: 3” of selection item order information of the selection item I1 described in the BML document 21.

As is described above, in the third embodiment, in cases where a selection item is selected by operating the coordinate input device 49, the same operation as that performed by using the up, down, right and left buttons 8 to 11 can be efficiently performed in the transfer of the selected state.

Embodiment 4

In the first to third embodiments, the coordinate input device 49 is used as a cursor control means. However, in a fourth embodiment, a mouse is used as a cursor control means.

Therefore, because the user is practiced in using the mouse in the operation of a personal computer, operability in the selection of a desired selection item can be further heightened.

Embodiment 5

In the first to third embodiments, the coordinate input device 49 is used as a cursor control means. However, in a fifth embodiment, a stick type input device is used as a cursor control means.

Therefore, because the user is practiced in using the stick type input device, operability in the selection of a desired selection item can be further heightened.

Here, the stick type input device can be assembled into a remote control device. In this case, operability in the selection of a desired selection item can be heightened by operating the remote control device.

Embodiment 6

In the first to third embodiments, the coordinate input device 49 is used as a cursor control means. However, in a sixth embodiment, a ball type input device is used as a cursor control means.

Therefore, because the user is practiced in using the ball type input device, operability in the selection of a desired selection item can be further heightened.

Here, the ball type input device can be assembled into a remote control device. In this case, operability in the selection of a desired selection item can be heightened by operating the remote control device.

What is claimed is:

1. A data broadcast receiving system comprising:
selection item displaying means for receiving a document, in which position information of a plurality of selection items is described, and displaying the selection items on a browser screen according to the position information of the selection items described in the document;
cursor control means for controlling a position of a cursor displayed on the browser screen; and
selection item determining means for judging whether or not the cursor controlled by the cursor control means is placed on a display area of one selection item displayed on the browser screen by the selection item displaying means and setting one selection item corresponding to one display area, on which the cursor is placed, to a selected state.

2. A data broadcast receiving system according to claim 1, wherein a change of the selection item set to the selected state is performed by the selection item determining means according to selection item order information which indicates the order of selection items set to the selected state one after another by operating up, down, right and left buttons and is described in the document.

3. A data broadcast receiving system according to claim 2, wherein it is allowed to perform a change of one selection item set to the selected state to another second selection item through each of a plurality of routes, a shortest route is selected by the selection item determining means from the routes, and the change of one selection item set to the selected state to another second selection item is performed by the selection item determining means according to the selection item order information relating to the shortest route.

4. A data broadcast receiving system according to claim 1, wherein the cursor control means is formed of a mouse.

5. A data broadcast receiving system according to claim 1, wherein the cursor control means is formed of a stick type input device.

6. A data broadcast receiving system according to claim 1, wherein the cursor control means is formed of a ball type input device.

7. A data broadcast receiving system according to claim 5, wherein the stick type input device is arranged on a remote control unit.

8. A data broadcast receiving system according to claim 6, wherein the ball type input device is arranged on a remote control unit.
